(19) United States
(12) Patent Application Publication
(10) Pub. No.: US 2004/0096107 A1
(43) Pub. Date: May 20, 2004

(54) Method and computer program product for determining an efficient feature set and an optimal threshold confidence value for a pattern recogniton classifier

(75) Inventors: David L. Ii, Owego, NY (US); Elliott D. Reitz II, Bradenton, FL (US); Dennis A. Tillotson, Glen Aubrey, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed martin Corporation

(21) Appl. No.: 10/294,534

(22) Filed: Nov. 14, 2002

(51) Int. Cl. G06K 9/62

(52) U.S. Cl. 382/224

(57) ABSTRACT

A method and computer program product are disclosed for determining an efficient set of features and an optimal confidence threshold value for a pattern recognition system with at least one output class. An initial set of features is selected based upon an optimization algorithm. A plurality of pattern samples are then classified using the selected feature set. A threshold confidence value is optimized as to maximize the accuracy of the classification. The selected feature set and threshold confidence value are accepted if a cost function based upon classification accuracy meets a predetermined threshold cost function value. The feature set is changed, by adding, removing or replacing a feature within the set based upon the optimization algorithm, if the cost function does not meet the predetermined threshold cost function value.

### BACKGROUND OF THE INVENTION

1. Technical Field

The invention relates to a system for determining an efficient set of features and an optimal confidence value for a pattern recognition device or classifier. Image processing systems often contain pattern recognition devices (classifiers).

2. Description of the Prior Art

Pattern recognition systems, loosely defined, are systems capable of distinguishing between various classes of real world stimuli according to their divergent characteristics. A number of applications require pattern recognition systems, which allow a system to deal with unrefined data without significant human intervention. By way of example, a pattern recognition system may attempt to classify individual letters to reduce a handwritten document to electronic text. Alternatively, the system may classify spoken utterances to allow verbal commands to be received at a computer console. In order to classify real-world stimuli, however, it is necessary to train the classifier to discriminate between classes by exposing it to a number of sample patterns.

The performance of any classifier depends heavily on the characteristics, or features, used to discriminate between the classes. A poorly chosen feature set can greatly retard the speed and accuracy of a classification system. Unfortunately, it is difficult to determine which features best distinguish between a set of output classes, especially when the number of output classes becomes large. Accordingly, a method of automating the feature selection process would be desirable.

Likewise, it is often desirable to reject samples that have not been classified with a specific level of confidence. New or severely defective samples will occasionally appear in operation of a classifier. Thus, a classifier must have some way to dispose of samples that are not associated with a represented output class. To be effective, this threshold value must be sufficiently large to filter out incorrect classifications, but must be kept small enough as not to interfere with the legitimate classification of samples into the represented classes. It would be desirable to provide a method of fixing the threshold value without undue experimentation.

### SUMMARY OF THE INVENTION

In accordance with one aspect of the present invention, a method is disclosed for determining an efficient set of features and an optimal confidence threshold value for a pattern recognition system with at least one output class. An initial set of features is selected based upon an optimization algorithm. A plurality of pattern samples are then classified using the selected feature set.

A threshold confidence value is optimized as to maximize the accuracy of the classification. The selected feature set and threshold confidence value are accepted if a cost function based upon classification accuracy meets a predetermined threshold cost function value. The feature set is changed, by adding, removing or replacing a feature within the set based upon the optimization algorithm, if the cost function does not meet the predetermined threshold cost function value.

In accordance with another aspect of the present invention, a computer program product is disclosed for determining an efficient set of features for a pattern recognition system with at least one output class. A selection portion selects an initial set of features based upon an optimization algorithm. A classification portion then classifies a plurality of pattern samples using the selected feature set. A threshold optimization portion optimizes a threshold confidence value to maximize the accuracy of the classification. Finally, an evaluation portion accepts the selected feature set and threshold confidence value if a cost function based upon classification accuracy meets a predetermined cost function threshold. The feature set is changed, by adding, removing or replacing a feature within the set based upon the optimization algorithm, if the cost function does not meet the predetermined cost function threshold.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is an illustration of an exemplary neural network utilized for pattern recognition;

FIG. 2 is a functional diagram of a classifier compatible with the present invention;

FIG. 3 is a flow diagram illustrating the training of a classifier compatible with the present invention;

FIG. 4 is a flow diagram illustrating the run-time operation of the present invention;

FIG. 5 is a schematic diagram of an example embodiment of the present invention in the context of a postal indicia recognition system.

### DETAILED DESCRIPTION OF THE INVENTION

In accordance with the present invention, a method for selecting an effective feature set for a pattern recognition classifier is described. The method may be applied to classifiers used in any traditional pattern recognition classifier task, including, for example, optical character recognition (OCR), speech translation, and image analysis in medical, military, and industrial applications.

It should be noted that the pattern recognition classifier for which sample sets are produced by the present invention will typically be implemented as a computer program, preferably a program simulating, at least in part, the functioning of a neural network. Accordingly, understanding of the present invention will be facilitated by an understanding of the operation and structure of a neural network.

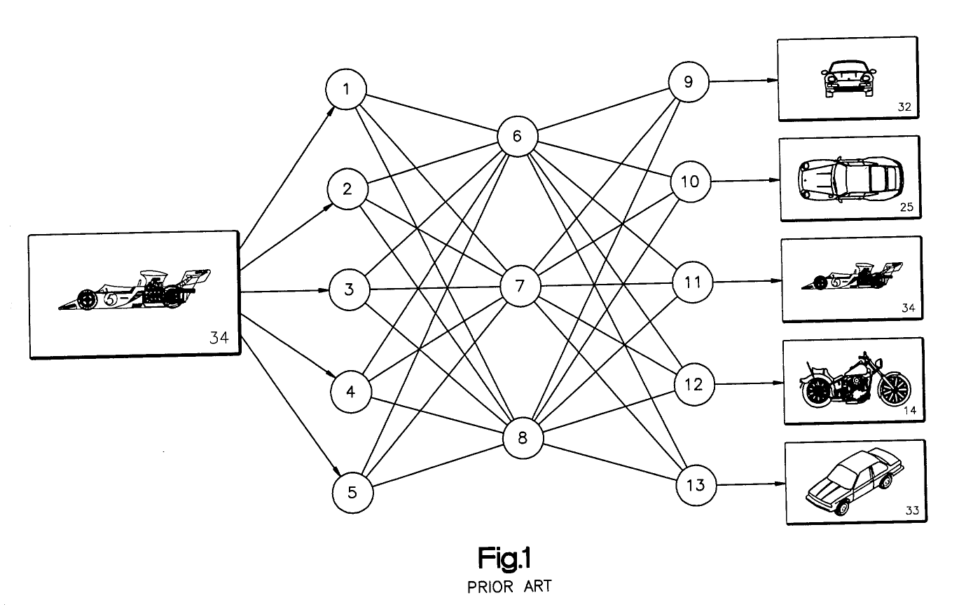

FIG. 1 illustrates a neural network that might be used in a pattern recognition task. The illustrated neural network is a three-layer back-propagation neural network used in a pattern classification system. It should be noted here, that the neural network illustrated in FIG. 1 is a simple example solely for the purposes of illustration. Any non-trivial application involving a neural network, including pattern classification, would require a network with many more nodes in each layer. In addition, additional hidden layers might be required.

In the illustrated example, an input layer comprises five input nodes, 1-5. A node, generally speaking, is a processing unit of a neural network. A node may receive multiple inputs from prior layers which it processes according to an internal formula. The output of this processing may be provided to multiple other nodes in subsequent layers. The functioning of nodes within a neural network is designed to mimic the function of neurons within a human brain.

Each of the five input nodes 1-5 receives input signals with values relating to features of an input pattern. By way of example, the signal values could relate to the portion of an image within a particular range of grayscale brightness. Alternatively, the signal values could relate to the average frequency of an audio signal over a particular segment of a recording. Preferably, a large number of input nodes will be used, receiving signal values derived from a variety of pattern features.

Each input node sends a signal to each of three intermediate nodes 6-8 in the hidden layer. The value represented by each signal will be based upon the value of the signal received at the input node. It will be appreciated, of course, that in practice, a pattern classification neural network may have a number of hidden layers, depending on the nature of the classification task.

Each connection between nodes of different layers is characterized by an individual weight. These weights are established during the training of the neural network. The value of the signal provided to the hidden layer by the input nodes is derived by multiplying the value of the original input signal at the input node by the weight of the connection between the input node and the intermediate node. Thus, each intermediate node receives a signal from each of the input nodes, but due to the individualized weight of each connection, each intermediate node receives a signal of different value from each input node. For example, assume that the input signal at node 1 is of a value of 5 and the weight of the connection between node 1 and nodes 6-8 are 0.6, 0.2, and 0.4 respectively. The signals passed from node 1 to the intermediate nodes 6-8 will have values of 3, 1, and 2.

Each intermediate node 6-8 sums the weighted input signals it receives. This input sum may include a constant bias input at each node. The sum of the inputs is provided into an transfer function within the node to compute an output. A number of transfer functions can be used within a neural network of this type. By way of example, a threshold function may be used, where the node outputs a constant value when the summed inputs exceed a predetermined threshold. Alternatively, a linear or sigmoidal function may be used, passing the summed input signals or a sigmoidal transform of the value of the input sum to the nodes of the next layer.

Regardless of the transfer function used, the intermediate nodes 6-8 pass a signal with the computed output value to each of the nodes 9-13 of the output layer. An individual intermediate node (i.e. 7) will send the same output signal to each of the output nodes 9-13, but like the input values described above, the output signal value will be weighted differently at each individual connection. The weighted output signals from the intermediate nodes are summed to produce an output signal. Again, this sum may include a constant bias input.

In a pattern recognition application, each output node represents an output class of the classifier. The value of the output signal produced at each output node represents the probability that a given input sample belongs to the associated class. In an example system, the class with the highest associated probability is selected, so long as the probability exceeds a predetermined threshold value. The value represented by the output signal is retained as a confidence value of the classification.

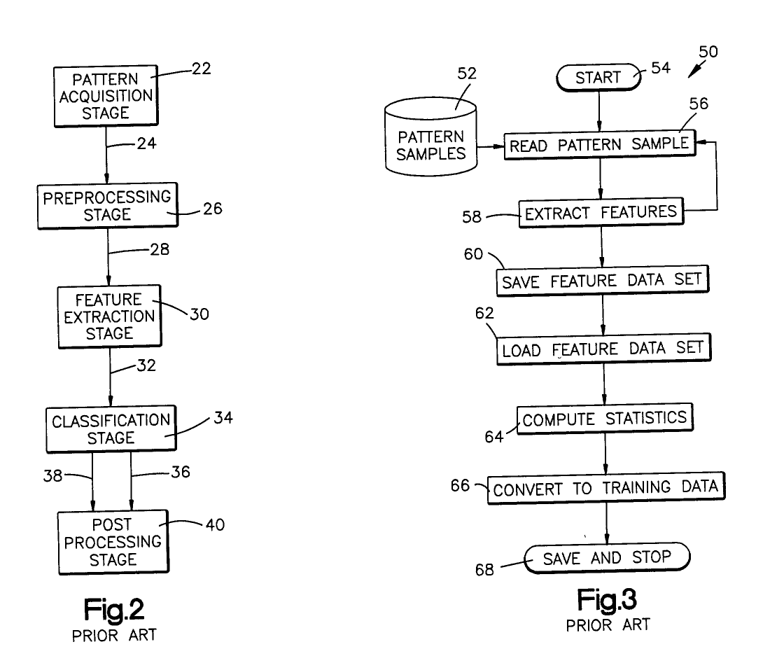

FIG. 2 illustrates a classification system 20 that might be used in association with the present invention. As stated above, the present invention and any associated classification system are usually implemented as software programs. Therefore, the structures described herein may be considered to refer to individual modules and tasks within these programs.

Focusing on the function of a classification system 20 compatible with the present invention, the classification process begins at a pattern acquisition stage 22 with the acquisition of an input pattern. The pattern 24 is then sent to a preprocessing stage 26, where the pattern 24 is preprocessed to enhance the image, locate portions of interest, eliminate obvious noise, and otherwise prepare the pattern for further processing.

The selected portions of the pattern 28 are then sent to a feature extraction stage 30. Feature extraction converts the pattern 28 into a vector 32 of numerical measurements, referred to as feature variables. Thus, the feature vector 32 represents the pattern 28 in a compact form. The vector 32 is formed from a sequence of measurements performed on the pattern. Many feature types exist and are selected based on the characteristics of the recognition problem.

The extracted feature vector 32 is then provided to a classification stage 34. The classification stage 34 relates the feature vector 32 to the most likely output class, and determines a confidence value 36 that the pattern is a member of the selected class. This is accomplished by a statistical or neural network classifier. Mathematical classification techniques convert the feature vector input to a recognition result 38 and an associated confidence value 36. The confidence value 36 provides an external ability to assess the correctness of the classification. For example, a classifier output may have a value between zero and one, with one representing maximum certainty.

Finally, the recognition result 38 is sent to a post-processing stage 40. The post-processing stage 30 applies the recognition result 38 provided by the classification stage 34 to a real-world problem. By way of example, in a stamp recognition system, the post-processing stage might keep track of the revenue total from the classified stamps.

FIG. 3 is a flow diagram illustrating the operation of a computer program 50 used to train a pattern recognition classifier via computer software. A number of pattern samples 52 are collected or generated. The number of pattern samples necessary for training varies with the application. The number of output classes, the selected features, and the nature of the classification technique used directly affect the number of samples needed for good results for a particular classification system. While the use of too few images can result in an improperly trained classifier, the use of too many samples can be equally problematic, as it can take too long to process the training data without a significant gain in performance.

The actual training process begins at step 54 and proceeds to step 56. At step 56, the program retrieves a pattern sample from memory. The process then proceeds to step 58, where the pattern sample is converted into a feature vector input similar to those a classifier would see in normal run-time operation. After each sample feature vector is extracted, the results are stored in memory, and the process returns to step 56. After all of the samples are analyzed, the process proceeds to step 60, where the feature vectors are saved to memory as a set.

The actual computation of the training data begins in step 62, where the saved feature vector set is loaded from memory. After retrieving the feature vector set, the process progresses to step 64. At step 64, the program calculates statistics, such as the mean and standard deviation of the feature variables for each class. Intervariable statistics may also be calculated, including a covariance matrix of the sample set for each class. The process then advances to step 66 where it uses the set of feature vectors to compute the training data. At this step in an example embodiment, an inverse covariance matrix is calculated, as well as any fixed value terms needed for the classification process. After these calculations are performed, the process proceeds to step 68 where the training parameters are stored in memory and the training process ends.

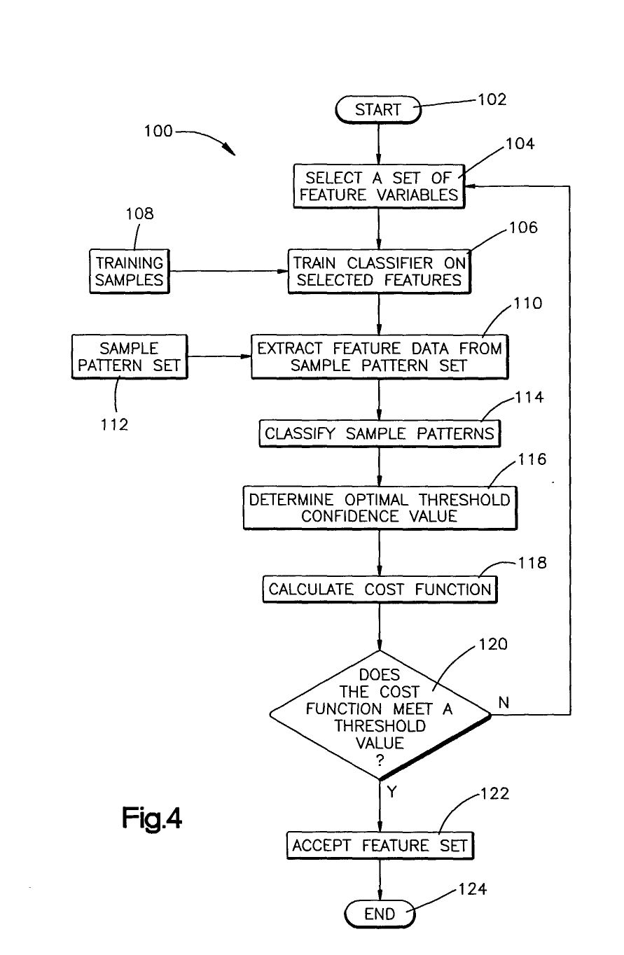

FIG. 4 is a flow diagram illustrating the run-time operation of the present invention. The process 100 begins at step 102. The process then advances to step 104, where the system selects a set of feature variables. The selection may take place by a number of means. The simplest of these would entail checking each feature in a predetermined order, but preferably the process will be streamlined using optimization techniques such as a gradient search or a genetic optimization algorithm. Such optimization techniques are known in the art. Alternatively, the set of features for each trial can be selected by a human operator.

Regardless of how the features are initially selected, the system proceeds to step 106, where the classifier is trained on a set of known training samples 108 using the selected features. The process then advances to step 110, where feature data corresponding to the selected features is extracted from a sample pattern set 112. Both the training samples and the sample pattern set will have been previously classified, likely by a human being.

The process then advances to step 114, where the classifier classifies the sample patterns, as if it were receiving them as run-time inputs. For each sample, the system determines an associated class and calculates a confidence value for the classification. Given the iterative nature of the selection process disclosed in the present invention, the classifier used in this process must be very efficient. Specifically, the classification technique used must be capable of rapidly and accurately classifying a significant number of pattern samples.

The process then proceeds to step 116, where an optimal threshold confidence value is determined. The threshold confidence value is a confidence value below which a classification will be rejected. Pattern samples classified with an associated confidence value falling below this threshold confidence value are considered to be associated with a class not represented by the system. An optimization algorithm, such as a genetic optimization or a discrete gradient search, is used to determine the threshold confidence value that produces an optimal classification accuracy. Data for this analysis is readily available, as confidence values were determined for all of the classifications during the classification stage. When the optimization process is complete, both a determined confidence value threshold and an associated accuracy will be outputted.

The process then proceeds to step 118, where a numerical score based on a cost function is calculated. Generally, this cost function will be some function of the accuracy of the classification results and the time necessary to complete the classification process. The cost function, however, can take into account other variables as well, such as the time necessary to train the classifier, the variation in the times necessary to classify a sample, or any similar quantities.

The process continues at step 120, where the calculated value from the cost function is compared to a threshold value. Where the calculated cost value fails to meet the threshold value, the system rejects the selected feature set, and returns to step 104 to select a new feature set. If the calculated cost value fails to meet the threshold value, the process advances to step 122, where the selected feature set is accepted. After the successful selection of a sample set, the process terminates at step 124.

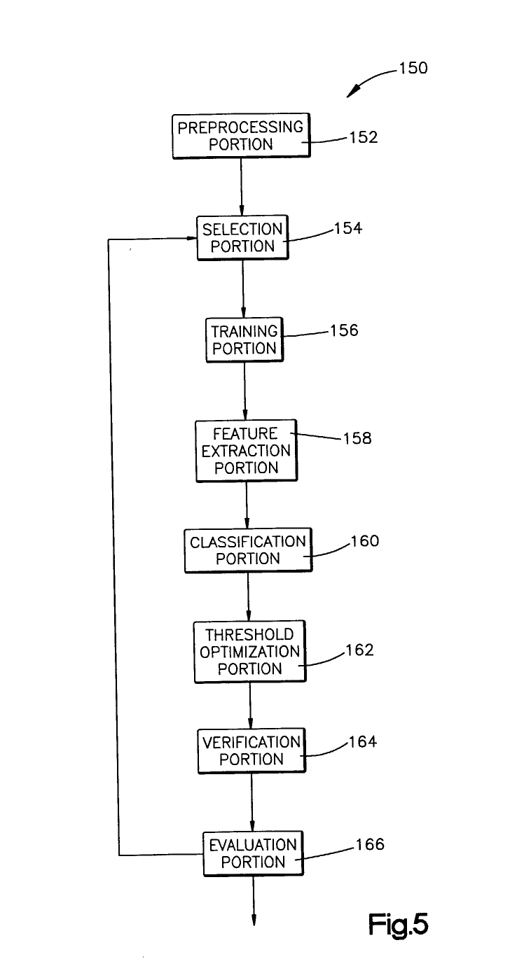

FIG. 5 is a schematic diagram of an example embodiment of the present invention in the context of a postal indicia recognition system. The system 150 first preprocesses a number of image samples at a preprocessing portion 152. At the preprocessing portion 152, extraneous portions of the images are eliminated. In the example embodiment, the system locates any potential postal indicia within the envelope image. The images are segmented to isolate the postal indicia into separate image segments and extraneous portions of the image segments are cropped. Any rotation of the images is corrected to a standard orientation. The preprocessing portion 152 then creates an image representation of reduced size to facilitate feature extraction. These image segments are then stored in memory for later use.

The selection portion 154 selects a set of feature values for analysis. In the example embodiment, features are selected through use of a discrete gradient search algorithm. In the discrete gradient search algorithm, the features are tested individually, then in pairs, and finally in sets of three. After each stage of the testing, the results are analyzed to determine which features caused in the greatest decreases in a cost function upon their addition to a feature set. This can be envisioned as a map of the cost function across feature space, with the analysis attempting to select the minimum value on the map. As the process continues, larger combinations will be selected for analysis using this data. As an alternate embodiment, a genetic optimization algorithm may be used. As part of a genetic optimization process, a prior feature set may be “mutated” by the addition or replacement of a feature in accordance with techniques used in genetic algorithms between iterations of the optimization process. This process will continue until a desired performance level is reached (i.e. the cost function meets a threshold value).

Upon selection of a feature set, the system is trained at a training portion 156. In the training portion, the system is trained on the selected features using a previously generated sample set. In the example embodiment, the associated class for each of these samples has been determined by a human being prior to training the classifier.

After training, a feature extraction portion 158 extracts feature data from a second set of pattern samples. Like the sample set used for training, the associated class for each of these samples is known, preferably by human classification. In the example embodiment, possible features include a histogram feature set containing sixteen histogram feature variables, and a downscaled feature set, containing sixteen “Scaled 16” feature variables.

A scanned grayscale image consists of a number of individual pixels, each possessing an individual level of brightness, or grayscale value. The histogram feature variables focus on the grayscale value of the individual pixels within the image. Each of the sixteen histogram variables represents a range of grayscale values. The values for the histogram feature variables are derived from a count of the number of pixels within the image having a grayscale value within each range. By way of example, the first histogram feature variable might represent the number of pixels falling within the lightest sixteenth of the range all possible grayscale values.

The “Scaled 16” variables represent the average grayscale values of the pixels within sixteen preselected areas of the image. By way of example, the sixteen areas may be defined by a four by four equally spaced grid superimposed across the image. Thus, the first variable would represent the average or summed value of the pixels within the extreme upper left region of the grid.

At the classification portion 160, the system classifies a known sample pattern set via a predetermined classification technique and measures the accuracy of the classification. The classification portion produces for each input pattern an associated classification result and a confidence value for the classification. The selected classification technique should be capable of rapidly and accurately classifying a significant number of pattern samples, to allow for a valid measurement of classifier accuracy. Further, the classification technique should be capable of producing an accurate confidence value.

The classifier of the example embodiment is a simulated compound neural network classifier. The compound classifier classifies a pattern sample in two stages. Initially, a relative comparison is made between the output classes to determine which class is most likely to be the class associated with the input pattern. Typically, this step involves the use of a modified Bayesian classification technique. After a class is selected, a confidence value is calculated for the selected class, reflecting the a posteriori probability that the pattern sample is associated with the selected class. This computation is usually accomplished via a classification technique based on a radial basis function. The compound classifier trains and classifies quickly, allowing its performance to provide a feasible feature metric for optimization.

The threshold optimization portion 162 optimizes a threshold confidence value portion based upon the accuracy of the classification it produces. The threshold confidence value determines when a classification result will be rejected. When the confidence value associated with the classification of an input pattern is below the threshold, the pattern is rejected as associated with a class not represented by the classifier. Thus, the accuracy of the classification varies as a direct function of the threshold confidence value. The optimization proceeds using an optimization technique, generally a gradient search technique or a genetic optimization technique, and the classification accuracy as an optimization metric. Since the confidence value for the classification of each pattern has already been calculated, it is simply necessary to select for the threshold confidence value that results in the highest accuracy, as measured by the percentage of samples correctly identified. In the preferred embodiment, the optimization is performed using a gradient search technique. The optimization process will output an optimal threshold confidence value and an associated classification accuracy.

After an optimal threshold confidence value is selected, a verification portion 164 computes a cost function based upon the classification results. This cost function can be any reasonable measure of classifier efficiency. In the example embodiment, the cost function is computed as follows:

Cost=k₁*t+k₂*a, where: Equation 1

t=time needed to complete the entire classification process;

a=the percentage of samples incorrectly classified or rejected (not classified) by the system;

k₁, k₂=constant factors.

The above formula can be modified in a number of ways. For example, the training and feature extraction time can be excluded from the time variable above. The accuracy variable might include only misclassification or the cost function could be redefined to use a variable representing the percentage of correctly classified samples. Further, other formula structures may be more useful in providing a metric for optimization. The cost function will depend on the application and the classification technique being used and is best determined by experimentation.

An evaluation portion 166 determines if the system is sufficiently efficient with the selected features by comparing the calculated cost function to a threshold value. Depending on the nature of the cost function, the cost function threshold may be a minimum or a maximum value for acceptance. In the example embodiment, if the calculated cost is below a threshold cost function value, the system will accept the selected features and report them as suitable features for the application of interest. If the calculated cost exceeds the threshold cost function value, the feature set will be rejected, and the system will alter the feature set according to the gradient map and repeat the analysis. The value of the cost function threshold will vary according to the structure of the cost function and the nature of the application.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A method of determining an efficient set of features and an optimal threshold confidence value for a pattern recognition system with at least one output class, comprising:
selecting an initial set of features based upon an optimization algorithm;
classifying a plurality of pattern samples using the selected feature set;
optimizing a threshold confidence value to maximize the accuracy of the classification;
accepting the selected feature set and threshold confidence value if a cost function based upon classification accuracy meets a predetermined threshold cost function value; and
changing the feature set, by adding, removing or replacing a feature within the set based upon the optimization algorithm, if the cost function does not meet the predetermined threshold cost function value.

2. A method as set forth in claim 1, wherein the step of selecting an initial set of features according to an optimization algorithm includes the use of a genetic selection algorithm.

3. A method as set forth in claim 1, wherein the step of selecting an initial set of features according to an optimization algorithm includes the use of a discrete gradient search technique.

4. A method as set forth in claim 1, wherein the step of optimizing the threshold value includes the use of a genetic selection algorithm.

5. A method as set forth in claim 1, wherein the step of optimizing the threshold confidence value includes the use of a gradient search algorithm.

6. A method as set forth in claim 1, wherein the step of classifying a plurality of pattern samples includes the use of a two-stage compound classifier.

7. A method as set forth in claim 1, wherein said cost function is calculated as the sum of the multiplicative product of the time necessary to complete a classification and a first factor and the multiplicative product of an error rate for the classification and a second factor.

8. A method as set forth in claim 1, wherein the plurality of pattern samples includes scanned images.

9. A method as set forth in claim 8, wherein at least of the one output class(es) represents an alphanumeric character.

10. A method as set forth in claim 8, wherein at least one of the output class(es) represents a type of postal indicia.

11. A computer program product for determining an efficient set of features and an optimal threshold confidence value for a pattern recognition system with at least one output class, comprising:
a selection portion that selects an initial set of features based upon an optimization algorithm;
a classification portion that classifies a plurality of pattern samples using the selected feature set;
a threshold optimization portion that optimizes a threshold confidence value to maximize the accuracy of the classification; and
an evaluation portion that accepts the selected feature set and threshold confidence value if a cost function based upon classification accuracy meets a predetermined cost function threshold and changes the feature set, by adding, removing or replacing a feature within the set based upon the optimization algorithm, if the cost function does not meet the predetermined cost function threshold.

12. A computer program product as set forth in claim 11, wherein the selection portion uses a genetic selection algorithm to select an initial set of features.

13. A computer program product as set forth in claim 11, wherein the selection portion uses a discrete gradient search technique to select an initial set of features.

14. A computer program product as set forth in claim 11, wherein the threshold optimization portion uses a genetic selection algorithm.

15. A computer program product as set forth in claim 11, wherein the threshold optimization portion uses a discrete gradient search technique.

16. A computer program product as set forth in claim 11, wherein the classification portion uses a two-stage compound classifier.

17. A computer program product as set forth in claim 11, wherein said cost function is calculated as the sum of the multiplicative product of the time necessary to complete a classification and a first factor and the multiplicative product of an error rate for the classification and a second factor.

18. A computer program product as set forth in claim 11, wherein the plurality of pattern samples includes scanned images.

19. A computer program product as set forth in claim 18, wherein at least one of the output class(es) represents an alphanumeric character.

20. A computer program product as set forth in claim 18, wherein at least one of the output class(es) represents a type of postal indicia.
